(19) United States
(12) Patent Application Publication
(10) Pub. No.: US 2015/0310986 A1
(43) Pub. Date: Oct. 29, 2015

(54) Electromagnetic Force Differential Propulsion Device

(71) Applicant: Michael Junior Spruill, Washington, NC (US)

(72) Inventor: Michael Junior Spruill, Washington, NC (US)

(21) Appl. No.: 14/580,348

(22) Filed: Dec. 23, 2014

Related U.S. Application Data
(60) Provisional application No. 61/984,107, filed on Apr. 25, 2014.
(60) Provisional application No. 62/040,396, filed on Aug. 21, 2014.
(60) Provisional application No. 62/066,915, filed on Oct. 22, 2014.

(51) Int. Cl. H01F 38/00; H01F 3/00

(52) U.S. Cl. CPC H01F 38/00; H01F 3/00

(57) ABSTRACT

The electromagnetic force differential propulsion device allows a change in the electrical power flowing into the device to directly change the force exerted by the device. The device unbalances a coiled wire's magnetic field by wrapping the wire around a spool acting as a very weak magnetic shield for part of its length and a strong magnetic shield for the remaining length. The weak magnetic shield hardly weakens the magnetic field in the spindle cavity it surrounds while the strong magnetic shield greatly weakens the magnetic field in its surrounded spindle cavity. The coiled wire is more strongly attracted to the strong magnetic field than the weak magnetic field and causes an unbalanced resultant force due to the fact that the spindle cavity (which is air) does not reciprocate magnetic attraction. This unbalanced attraction causes the wire to push on the spool causing the whole device to exert a force.

### CROSS-REFERENCES TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

The field of endeavor of the electromagnetic force differential propulsion device is USPC class 361—Electrical Systems and Devices, subclass 437—Miscellaneous and CPC class H02N—Electric Machines Not Otherwise Provided For. The invention is a special type of electrically powered gross motion device.

Although there is no prior art for this specific invention, the most common types of devices which exhibit motion are electric motors and gasoline motors. They are loud, pollutant-emitting, dangerous or inefficient.

Electric motors convert electrical energy into mechanical energy by rotating a usually multi-pole electromagnetic rotor within a usually multi-pole electromagnetic stator via magnetic repulsion. This method is inefficient because electrical power must continually be alternated to keep the poles of the stator and the poles of the rotor in constant repulsion. The magnetic repulsion method also creates a constant back electro-motive force (or voltage) that opposes the rotation of the rotor because the electrical conductors (or wires) carrying electrical current are moving through the magnetic field of the stator or rotor. Whenever electrical conductors move through a magnetic field flowing at right angles to the conductors, a voltage is induced in the moving electrical conductors. Lenz's law states that the induced voltage produces an electrical current in the conductors that opposes the flow of the input current to the electric motor so as to maintain the original magnetic flux in the circuit. Finally, for this conversion method, the force created by the motor for a given input power is maximum only when the magnetic fields of the rotor's magnetic poles and the stator's magnetic poles are anti-parallel and co-linear with each other. This same force is zero when the rotor's magnetic poles are perpendicular to the stator's magnetic poles. According to the number of poles in the conventional electric motor, a finite number of maximum points of force during the whole 360 degree rotation of the rotor exist. So force ranges from zero to a maximum value and then back to zero continuously and this produces an average velocity in a conventional motor. No matter what configuration or type of motor (shunt, series, combination, etc.) and no matter how the motor is electrically excited (alternating current, direct current, pulsed current), the conventional electric motor still suffers from the aforementioned problems.

Gasoline motors use combustible fuels like petroleum as their power source and they use gases as their propellants. The motor combusts (explodes) a fuel and then uses the energy from the heat of the combustion to move gases against the motor's inner cylinders to propel the object the motor is attached to.

The combustion method usually proves to be more powerful than the electromechanical method in the matter of moving objects but the combustion method does have its disadvantages. First, combustion requires a lot of usually very expensive fuel. Also, combustion causes pollutants to enter and harm the environment. Finally, the act of combustion is not only loud but dangerous due to the fact that combustion is basically small, controlled explosions.

In summary, electric motors are inefficient due to their internal physical arrangement. Gasoline motors, on the other hand, are not only loud but use expensive, deadly fuels and they are a major source of pollution.

### BRIEF SUMMARY OF THE INVENTION

The electromagnetic force differential propulsion device is a novel electrically powered gross-motion device. The electromagnetic force differential propulsion device experiences and exerts a force when electrical power from an electrical power source enters the insulated electrical wire wound around the magnetically permeable spool of the device. The best example of the device has a larger spool spindle hole diameter for the first half of the spool length than the spool spindle hole diameter for the second half of the spool length. The wire wound around the spool self-induces an electromagnetic force difference within itself to move the device with a force proportional to the electrical current flowing through the wire when the wire conducts electricity due to the internal physical layout of the spool body.

As written earlier, electric motors constantly endure back electro-motive force (voltage). The electromagnetic force differential propulsion device does not constantly endure back electro-motive force because there is no relative movement of the device's electrical conductors through any magnetic fields. Also, there is no need for a continual reversal of electrical power as with electric motors (due to the fact that electric motors must always repel). The electromagnetic force differential propulsion device will always have a maximum force for its input current which greatly increases the efficiency of the conversion of electrical energy to mechanical energy. The electromagnetic force differential propulsion device is relatively silent compared to gasoline motors and will not emit pollutants into the environment and does not need nor expel propellants. The electromagnetic force differential propulsion device will also not use expensive and combustible fuels which make using gasoline motors dangerous.

The electromagnetic force differential propulsion device is scalable. It can be large or small. The device replaces most of the transmission and gears of many vehicles. As such, it should be easy to install, maintain and replace.

In conclusion, the electromagnetic force differential propulsion device is a useful and novel electrically powered gross-motion device that uses a non-obvious, safe and efficient method to convert electrical energy to a mechanical force. This method is useful not only in the transportation industry for the propulsion of trains, buses, aircraft, spacecraft, marine craft and cars but also in the robotics industry for the movement of artificial limbs.

BRIEF DESCRIPTION OF THE SEVERAL VIEWS OF THE DRAWINGS

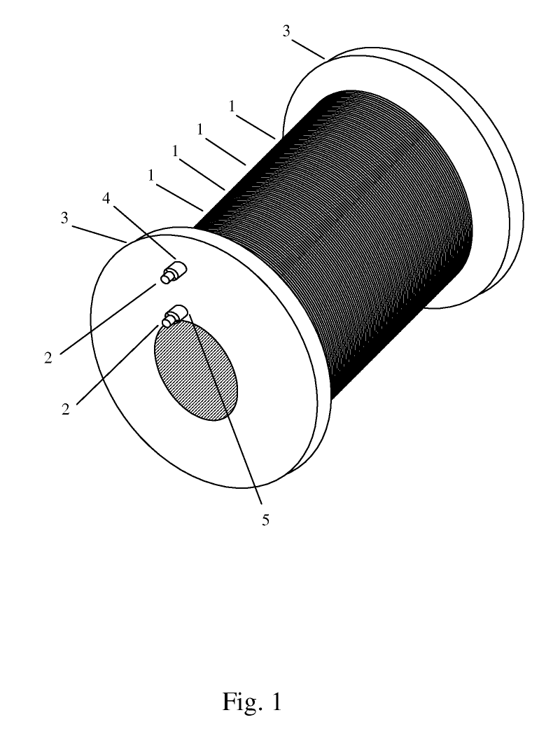

FIG. 1 depicts the perspective view of the electromagnetic force differential propulsion device.

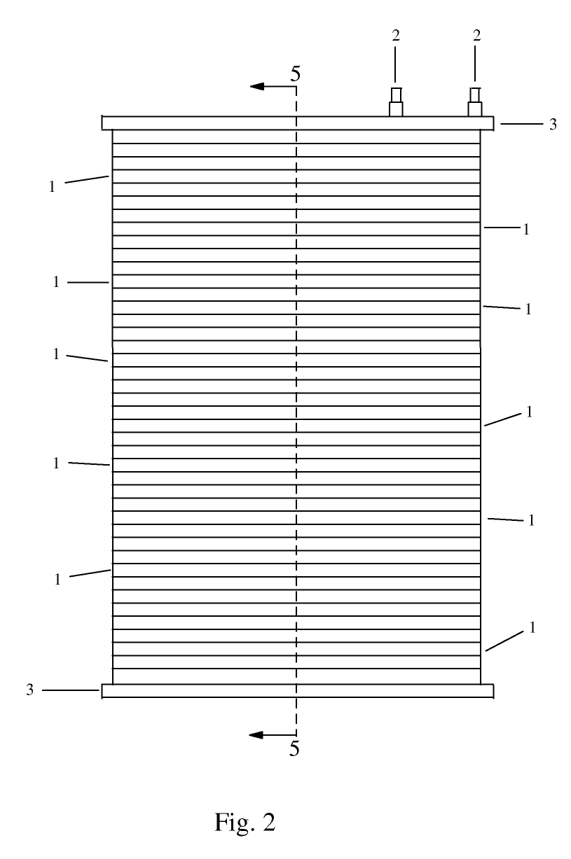

FIG. 2 depicts the elevation view of an example preferred embodiment of the electromagnetic force differential propulsion device.

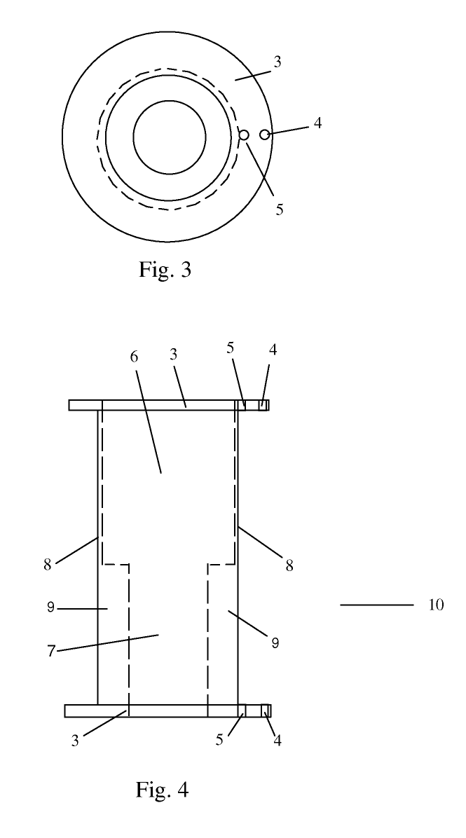

FIG. 3 depicts the plan view of the spool of an example preferred embodiment of the electromagnetic force differential propulsion device.

FIG. 4 depicts the elevation view of the spool of an example preferred embodiment of the electromagnetic force differential propulsion device.

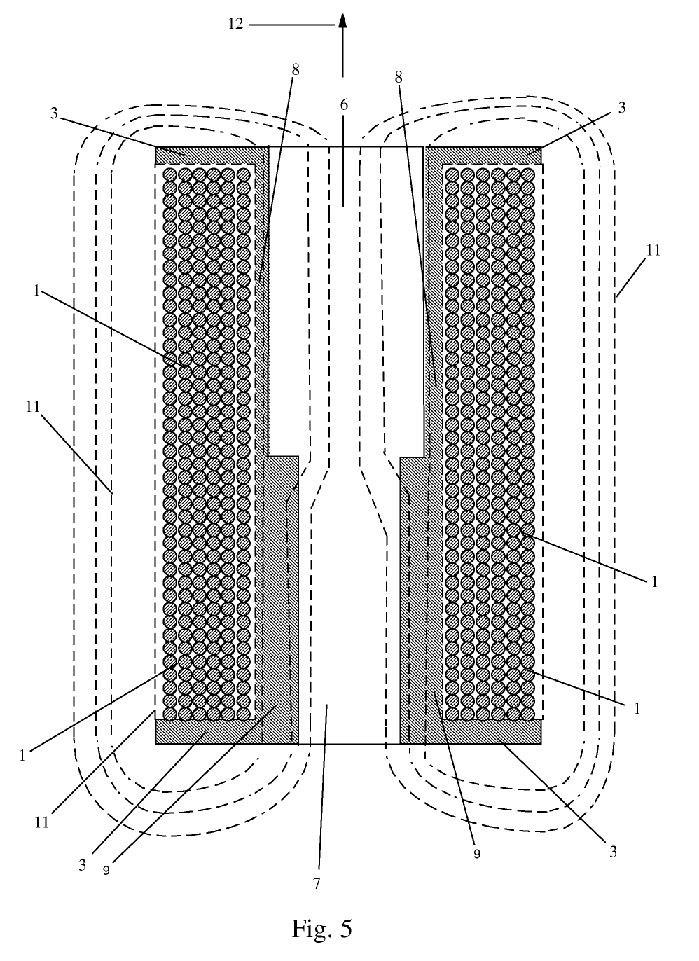

FIG. 5 depicts the section view of the example preferred embodiment of the electromagnetic force differential propulsion device of FIG. 2 while the device is electrically excited.

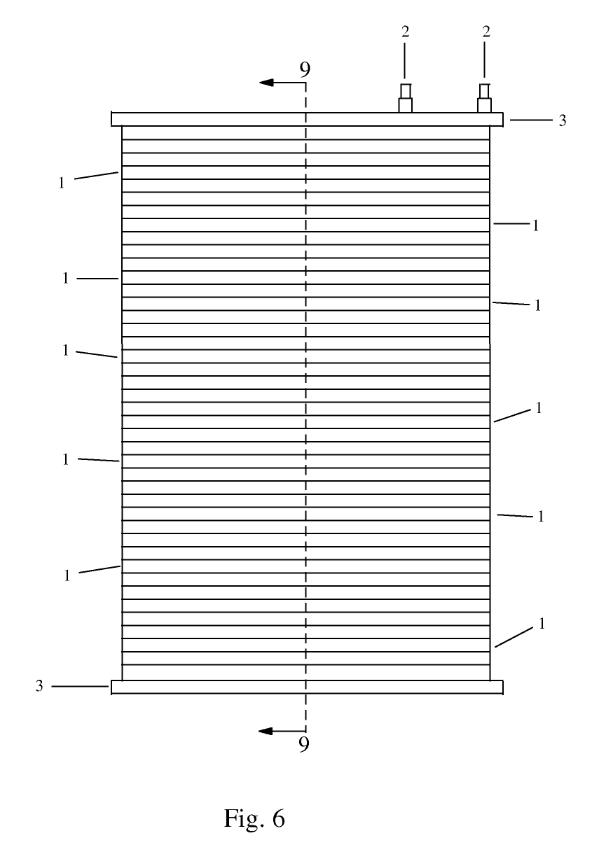

FIG. 6 depicts the elevation view of an embodiment of the electromagnetic force differential propulsion device featuring a magnetically permeable spool insert.

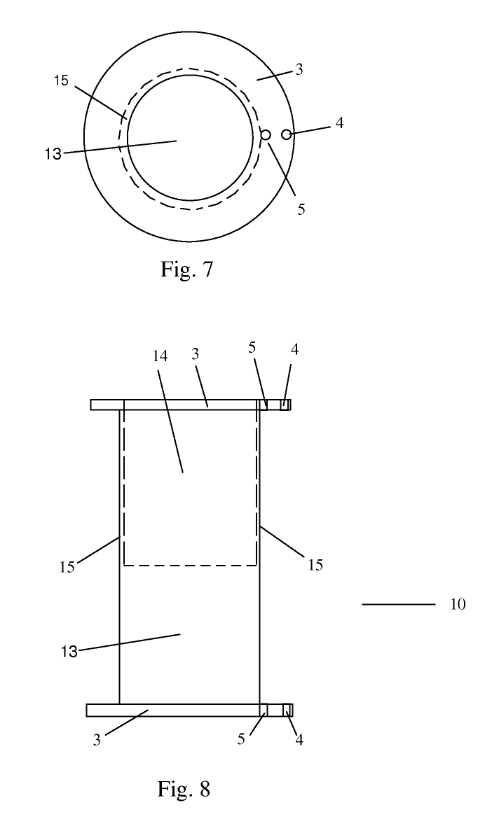

FIG. 7 depicts the plan view of the spool of an embodiment of the electromagnetic force differential propulsion device featuring a magnetically permeable spool insert.

FIG. 8 depicts the elevation view of the spool of an embodiment of the electromagnetic force differential propulsion device featuring a magnetically permeable spool insert.

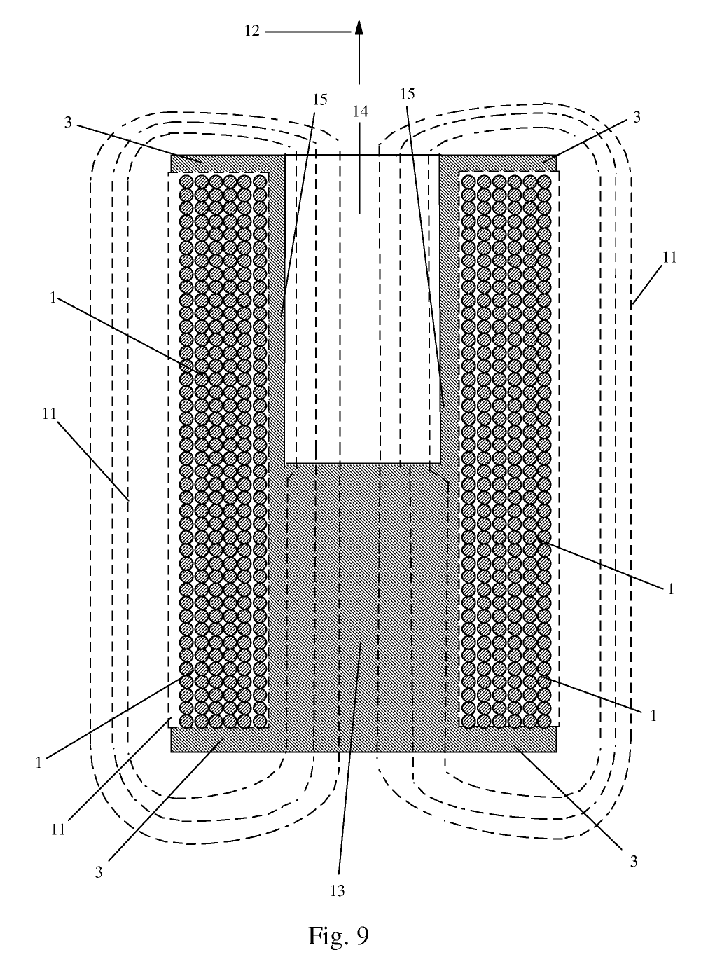

FIG. 9 depicts the section view of an embodiment of the electromagnetic force differential propulsion device of FIG. 6 while the device is electrically excited.

In the drawings, FIGS. 1-9 depict various aspects of an example preferred embodiment of the electromagnetic force differential propulsion device where numbers 1 through 15 represent a different feature of the device. Number 1 is the wire. Number 2 is the wire end. Number 3 is the spool flange. Number 4 is the upper wire slot. Number 5 is the lower wire slot. Number 6 is the larger spindle hole cavity. Number 7 is the smaller spindle hole cavity. Number 8 is the narrow spindle hole edge. Number 9 is the broad spindle hole edge. Number 10 is the spool body. Number 11 is the magnetic field lines (or paths) of the device. Number 12 is the resultant force exerted by the wire. Number 13 is the magnetically permeable spool insert. Number 14 is the general spindle hole cavity. Number 15 is the general spindle hole edge.

### DETAILED DESCRIPTION OF THE INVENTION

Magnetic energy flows throughout everything. Magnetic flux is the flowing path of magnetic energy. The numerical value of the magnetic flux (or the number of paths of magnetic energy (11)) is calculated by multiplying the magnetic field density (which is the number of paths of magnetic energy (11) in a given area) by the cross-sectional area of the material the magnetic energy is flowing through. Visualize water streams as paths of magnetic energy (11) and visualize any given object as a colander with a given number of holes in its unit area. The size of the area of the colander determines how many total holes the colander has. The magnetic field density is the number of water streams flowing throughout the holes in the given unit area of the colander divided by the given unit area of the colander. The magnetic field density has units of Webers/meter² (Wb/m²). The Weber is the unit of magnetic flux. One Weber/meter² (Wb/m²) is equal to one Tesla (T).

Each material—either magnetically permeable or not magnetically permeable—has its own magnetic permeability. Magnetic permeability is the measurement of how much magnetic flux will move through a given material from a magnetic energy source or how great the value of magnetic field density. In other words, as going by the aforementioned comparison, magnetic permeability determines how many holes per unit area the colander will have. The higher a given material's initial magnetic permeability is, the greater the number of magnetic energy paths (11) moving through the material will be and, therefore, the higher the material's magnetic field density is. Also to note, a ferromagnetic or ferrimagnetic material has a different magnetic permeability value for each value of magnetic field density it achieves or, in other words, as magnetic field density increases, magnetic permeability decreases. This means the number of magnetic energy paths (11) added to the material decreases. Magnetic field density increases with an increasing amount of electrical current going through the insulated electrical wire (1) wound around the material or with an increasing number of turns per unit length of the same wire (1) wound around that same material.

The preferred embodiment of the electromagnetic force differential propulsion device, as shown in FIGS. 1 and 2, is comprised of an insulated electrical wire (1) wound around the magnetically permeable spool body (10) of the device. The preferred embodiment of the magnetically permeable spool body (10) can be seen as consisting of two halves: the first half of the spool body (10) consists of a cylindrical volume of air named the larger spindle hole cavity (6) surrounded by a narrow edge of the spool body (10) named the narrow spindle hole edge (8); and the second half of the spool body (10) consists of a smaller cylindrical volume of air named the smaller spindle hole cavity (7) surrounded by a somewhat broader edge of the spool body (10) named the broad spindle hole edge (9) where both cylindrical volume lengths are equivalent. Other embodiments of the spool body (10) are not required to have identical cylindrical lengths but these embodiments produce less maximum force (12). Some different embodiments may have more than one non-magnetically permeable material comprising the spool body (10) as, for example, having one cavity surrounded by one non-magnetically permeable material and the second cavity being surrounded by a second non-magnetically permeable material.

The spool, as shown in FIGS. 3 and 4, is constructed in the aforementioned manner as to self-induce an electromagnetic force imbalance when the wire (1) surrounding the spool body (10) conducts electricity. The imbalance occurs because the magnetic field in the larger spindle hole cavity (6) is much larger than the magnetic field in the smaller spindle hole cavity (7). This happens because the spool body (10) acts as a very weak magnetic shield for the larger spindle hole cavity (6) and, simultaneously, the same spool body (10) acts as a strong magnetic shield for the smaller spindle hole cavity (7). The conducting wire (1) is attracted to the magnetic field in the larger spindle hole cavity (6) of the device more so than the said conducting wire (1) is attracted to the magnetic field in the smaller spindle hole cavity (7) of the device, therefore, making the conducting wire (1) move with a resultant force (12) that is the difference of the two forces of attraction created by the two different spindle hole cavities (6, 7). The larger spindle hole cavity (6) becomes a strong source of magnetic energy due to the fact that the narrow spindle hole edge (8) acts as a very weak magnetic shield which hardly weakens the electromagnetic field induced by the conducting wire (1) radiated into the larger spindle hole cavity (6) while the broad spindle hole edge (9) acts as a strong magnetic shield which greatly weakens the electromagnetic field induced by the conducting wire (1) radiated into the smaller spindle hole cavity (7). The conducting wire, which is attracted to its own created magnetic field, feels the pull of attraction from both cavities' (6, 7) magnetic fields and moves in the direction towards the strongest magnetic field density with a resultant force (12) that is the difference of the attraction forces created by the cavities (6, 7). The strongest magnetic field density will always reside in the larger spindle hole cavity (6). In other words, the conducting wire (1) will push in the direction of the larger spindle hole cavity (6). The spindle hole cavities (6, 7) do not attract to the conducting wire (1) because the spindle hole cavities (6, 7) are made of a non-magnetically permeable material (air). Therefore, the attractions between the conducting wire (1) and the spindle hole cavities (6, 7) are one-sided.

In conclusion, force (12) is exerted by any embodiment of the device because the wire (1) wound around the magnetically permeable spool body (10) experiences an unbalanced force (12) on itself when the wire (1) is conducting. In the preferred embodiment, the conducting wire (1) experiences this unbalanced force (12) due to the fact that the spool body (10) consists of a full-length spindle hole containing two unique arbitrarily sized cavities (6, 7) where each cavity's axial length takes up one half of the spool body's (10) spindle hole length and where the spool body (10) surrounds one of the cavities as a weaker magnetic shield than the other cavity. The conducting wire (1) pulls with more force on the cavity (6) with the weak magnetic shield than the other cavity (7) without the cavities (6, 7) being attracted to the conducting wire (1) themselves causing the unbalanced force (12). This non-zero net force (12) moves the conducting wire (1) and the device as shown in FIG. 5 as well as shown in an alternate embodiment in FIG. 9.

There are two different parts in the preferred embodiment of the electromagnetic force differential propulsion device. Other embodiments may be manufactured differently and include more parts using different materials.

Part One is the wire (1). There is one insulated wire (1) for each electromagnetic force differential propulsion device. The wire (1) is usually made of an electrically conductive material with non-electrically conductive insulation surrounding it. The wire (1) usually winds (or turns) around the spool of the device and exits the device via the wire slots (4, 5) in the spool flange (3). Each wire end (2) is connected to a different electrical terminal of the same electrical power source. The wire (1) induces a magnetic field in the spool cavities (6, 7) once the wire (1) conducts. The wire (1) also exerts a linear force on the spool flange (3), which moves the spool, once the wire (1) experiences a non-zero electromagnetic force (12) due to its unbalanced attraction with the spool spindle hole cavities (6, 7).

Part Two is the spool. There is one spool in each electromagnetic force differential propulsion device. The spool of the preferred embodiment of the device consists of the larger spindle hole cavity (6), the smaller spindle hole cavity (7), the spool flanges (3), the upper wire slots (4), the lower wire slots (5), the narrow spindle hole edge (8), and the broad spindle hole edge (9). The spool is made of a magnetically permeable material, except for the wire slots (4, 5), which are empty space, and the spindle hole cavities (6, 7) which are made of a non-magnetically permeable material (for example, air). This allows the force (12) of the device to move towards the larger spindle hole cavity (6). Though, in some embodiments of the device, as shown in FIG. 6, FIG. 7, FIG. 8 and FIG. 9, one of the spindle hole cavities (6, 7) actually comprises a magnetically permeable material and is renamed a magnetically permeable spool insert (13) as shown in FIG. 7 and FIG. 8. The magnetically permeable spool insert (13) can be seen as acting as a stronger magnetic shield than either of the original cavities (6, 7). The magnetically permeable spool insert (13) is not required to be of the same magnetically permeable material as the spool body (10). In fact, as long as the spool insert (13) is able to stay in place within the spool body (10), the spool insert (13) is not required to be physically attached to the spool body (10) and more than one can be featured in a device. In these embodiments, the force (12) of the device moves away from the spool insert (13) due to the fact that the magnetically permeable spool insert (13) will experience an equal and opposite attraction to the magnetic field of the wire (1). Also, in the embodiments featuring a magnetically permeable spool insert, there are no specifically named cavities or edges. Instead, the cavities in these embodiments are renamed the general spindle hole cavity (14) and the cavities' edges are renamed the general spindle hole edge (15). In at least another embodiment of the device, the spool insert (13) can be placed juxtaposed with a least another non-magnetically permeable cavity in addition to the general spindle hole cavity (14). The preferred embodiment of the spool body (10) generally comprises the spindle hole cavities (6, 7), the spindle hole edges (8, 9) and the spool flanges (3). To reiterate, the narrow spindle hole edge (8) acts as a very weak magnetic shield and fails to greatly attenuate the magnetic field inside the larger spindle hole cavity (6) which is emanated from the conducting wire (1) while the broad spindle hole edge (9) acts a strong magnetic shield and greatly attenuates the emanated magnetic field radiated to the smaller spindle hole cavity (7). To note, the axial lengths of the spindle hole cavities (6, 7) do not have to be equivalent. If the axial lengths are not equivalent, the maximum force (12) attainable by the device for that total spool body (10) length may be decreased significantly. Also, in some embodiments, the spindle hole cavities (6, 7, 14) do not have to be exactly cylindrical. In other words, the cavities (6, 7, 14) can be shaped as any n-prism where n can be any number from three to infinity, where an infinity-prism is also recognized as a cylinder. The change in the value of “n” may or may not increase the maximum force attainable. The spool holds the wire (1) in place by allowing the wire (1) to enter the spool through the lower wire slot (5), wind around the spool and exit through the upper wire slot (4). The conducting wire (1) pushes on the spool via the spool flange (3) which, in turn, pushes on outside objects to move them. The spindle hole edges (8, 9) and the spool flanges (3) making up the spool body (10) can be manufactured, machined, welded or otherwise fabricated in any way that allows the magnetically permeable material to keep its magnetically permeable qualities. The spool flanges (3) are not required to be discontinuous, or in other words, they do not have to have spindle hole cavity (6, 7) cut-outs. The spool flanges (3) may be solid throughout its entire cross-sectional area as the spool flanges (3) fall outside the volume around which the wire (1) is wound and each individual spool flange (3) width can be unequal. In alternate versions of the device, the spool flanges (3) may be a separate feature from the spool body (10). Also, the spool flanges (3) may be of a different material—whether that spool flange (3) material is magnetically permeable or not.

The following are guides to the design process and their corresponding design calculations for example ideal electromagnetic force gradient propulsion devices. As the initial conditions vary, the design processes may differ. Also, real world conditions will vary the exact performance of each individual device.

First, discover the initial conditions for the device.
Find: The specifications of a device moving a 268.5-kg (593-lb) object using the given energy source for the given time. Assume neither frictional forces nor air resistance.
Given: A 24 kiloWatt-hour energy source to be used no longer than 30 minutes at maximum power.
Mass=m=268.5-kg

Energy Source=E_{ELECTRICAL}=24×10³ Watt-hrs (W-hrs)=8.64×10⁷ Newton-meters (N-m)

Maximum Operating Time at Maximum Power=T_{MIN}=30 minutes=0.5 hours=1800 seconds

Next, find the maximum operating power (P_{DEVICE}) for the device.

P_{DEVICE}=E_{ELECTRICAL}/T_{MIN}=(24×10³ W-hrs)/(0.5 hrs)=48×10³ W=48×10³ N-m/s

Next, choose the wire size (wire gauge) and wire type desired for the device.
Chosen wire gauge: 16AWG Magnet Wire-200° C. (392° F.) Rating Insulation
   D_{16AWG}=1.29×10⁻³ m=0.051 inches (in)
   I_{16AWG}=32 Amps (A)

Next, the number of layers of turns of wire is calculated. This is done by a somewhat iterative method. First, a range of the number of layers of turns of wire is chosen. Then the maximum ambient temperature of the device is chosen. Each of the chosen values has a derating factor as given by the National Electrical Code (NEC) for the current flowing through the chosen wire gauge. Once the current is correctly calculated, the true number of layers of turns for the device can be found.
Chosen range of number of layers of turns=6-15=>Correction factor=CF_{BUNDLED}=0.7
Chosen maximum ambient temperature=100° C. (212° F.)=>Correction factor=CF_{TEMP}=0.77

I_{MAX}=[CF_{BUNDLED}]*[CF_{TEMP}]*[I_{16AWG}]=(0.7)*(0.77)*(32 A)=17.248 A

The chosen number of layers, N_{L}, will be 15 (N_{L}=15) as the maximum force possible is desired.

Next, calculate the maximum magneto-motive force (MMF_{MAX}) available.

MMF_{MAX}=[N_{L}*I_{MAX}]/[D_{16AWG}]

MMF_{MAX}=[15 t]*[17.248 A]/[1.29×10⁻³ m]=200558 A/m

Next, choose the magnetically permeable material for the spool body.
Chosen magnetically permeable material for spool body=1018 Steel

Now, choose the thickness of the narrow spindle hole edge. This must be large enough to be machined but small enough to cause a large magnetic field in the larger spindle hole cavity.
t_{EDGE1}=0.0015875 m=0.0625 in

Next, choose a value for the maximum magnetic field intensity (H_{CAVITY1}) and the magnetic field permeability (ur_{EDGE1}) to be desired in the larger spindle hole cavity and the narrow spindle hole edge. The value of H_{CAVITY1} cannot exceed MMF_{MAX} as MMF_{MAX} is the maximum magnetic energy placed within the cavities. A large value of H_{CAVITY1} will give larger force values but a longer cavity length as will be seen in the next step. The value of ur_{EDGE1} for the particular H_{CAVITY1} will be determined from the manufacturer's data sheets for the magnetically permeable material chosen to be the spool body. H_{CAVITY1} partly determines ur_{EDGE1} because the value of H_{CAVITY1} will also be seen in the narrow spindle hole edge.
H_{CAVITY1}=193680 A/m
ur_{EDGE1}=9.4 (by the data sheets for 1018 Steel for a magnetic field intensity of 193680 A/m.)

Next, calculate the length of the larger spindle hole cavity and the smaller spindle hole cavity (L_{CAVITY}) and the length of the spool (L_{SPOOL}). These lengths are the equal in value as to produce the maximum possible force. A special equation is derived to calculate L_{CAVITY}. The following equations are used to derive the equation: the shielding factor equation and the equation for the magnetic field intensity between two boundaries with a free current running between the boundaries as well as simple geometry equations. Because the outer magnetic field is going in the opposite direction as the magnetic field inside the cavity, the Shielding Factor is negative. A simultaneous solve of all equations is required to calculate L_{CAVITY}.

Shielding Factor=−H_{OUT}/H_{IN}=−H_{OUT}/H_{CAVITY}=[ur_{EDGE}*t_{EDGE}]/[L_{CAVITY}] (Shielding factor equation.)

−H_{OUT}=[ur_{EDGE}*t_{EDGE}*H_{CAVITY}]/[L_{CAVITY}] (Re-written shielding factor equation.)

H_{CAVITY}−H_{OUT}=MMF_{MAX} (This is the tangential boundary condition of the cavity.)

[1+[ur_{EDGE}*t_{EDGE}]/[L_{CAVITY}]]*H_{CAVITY}=MMF_{MAX} (Resultant equation.)

L_{CAVITY}=[t_{EDGE}*ur_{EDGE}]/[(MMF_{MAX}/H_{CAVITY})−1] (Derived equation.)

L_{CAVITY}=(0.0015875m*9.4)/[(200558 A/m)/(193680 A/m)−1]=0.4202m=16.54 in

L_{SPOOL}=2*L_{CAVITY}=2*(0.4202m)=0.8404 m=33.08 in

Next, calculate total resistance of the device at steady state. For this calculation, caution must be made. Since the device resembles a segmented inductor, back electromotive force (EMF) plays a major role in determining the power requirements needed to achieve maximum acceleration. The formula, Power=[I(t)]²*[Resistance]/[(1−e^{-t/τ})²], will be used where I(t) will equal I_{MAX} and t will equal τ (in other words, t/τ=1).

R_{DEVICE}=P_{DEVICE}*(1−e⁻¹)²/I²_{MAX}=(48×10³ W)*(1−e⁻¹)²/(17.248 A)²=64.47 Ω

Now, calculate the total length of wire used by the device.

ρ_{copper}=1.7×10⁻⁸ Ω−m

A_{16AWG}=1.307×10⁻⁶ m²

L_{WIRE}=R_{DEVICE}*A_{16AWG}/ρ_{copper}=4957 m=16263 ft

Calculate the radius and diameter of the larger spindle hole cavity as well as the diameter of the spool body.

L_{WIRE}=[2*Pi*(r_{CAVITY1}+t_{EDGE1}+½*N_{L}*D_{16AWG})]*[N_{L}/D_{16AWG}]*[L_{SPOOL}]

r_{CAVITY1}=[L_{WIRE}*D_{16AWG}]/ [(2*Pi*N_{L}*L_{SPOOL})−t_{EDGE1}−½*N_{L}*D_{16AWG}]=0.1502 m=5.913 in

D_{CAVITY1}=2*r_{CAVITY1}=0.3004 m=11.827 in

D_{SPOOL}=D_{CAVITY1}+2*t_{EDGE1}=0.303575 m=11.952 in

Now calculate the maximum field intensity (H_{CAVITY2}) and its relative magnetic permeability to be desired in the smaller spindle hole cavity. This value can be any percentage of H_{CAVITY1} but 50% usually gives the maximum force.

H_{CAVITY2}=(0.5)*H_{CAVITY1}=96840 A/m
ur_{EDGE2}=18 (by the data sheets for 1018 Steel for a magnetic field intensity of 96840 A/m.)

Now, calculate the thickness of the broad spindle hole edge and the diameter of the smaller spindle hole cavity.

t_{EDGE2}=[(MMF_{MAX}/H_{CAVITY2})−1]*[L_{CAVITY}/ur_{EDGE2}]=0.0250 m=0.984 in

D_{CAVITY2}=D_{SPOOL}−2*t_{EDGE2}=0.253575 m=9.983 in

Next, calculate the effective area (A_{EFF}) of the device. The effective area is the cross-sectional area which force will be calculated from. The effective area is also the cross-sectional area of D_{CAVITY2} as it is the smallest and, therefore, the limiting factor.

A_{EFF}=Pi*D²_{CAVITY2}/4=[Pi*(0.253575m)²]/4=0.0505 m²

Now, calculate the actual number of turns that will be wound on the device.

N_{CAVITY}=L_{CAVITY}/D_{16AWG}*N_{L}=(0.4202 m)/(1.29×10⁻³ m)*15 t=4886 t

Now calculate the difference in the stored energy (W_{M}) between the smaller spindle hole cavity and the larger spindle hole cavity. Stored energy is derived from the equation: ΔW_{M}=½*N*I*ΔB*A where ΔB=uo*ΔH.

ΔW_{M}=½*N_{CAVITY}*I_{MAX}*uo*(H_{CAVITY1}−H_{CAVITY2}))*A_{EFF}=258.95 J=258.95 N-m

Next, from the difference in stored energy, the electromagnetic force exerted on and by the device can be calculated due to the fact that both cavities are the same length which is L_{CAVITY}.

F_{DEVICE}=ΔW_{M}/L_{CAVITY}=[(258.95 N-m)/(0.4202m)]=616 N=138.7 lbs

Next, calculate the radius of the spool flanges. The spool flange radius must be able to hold all the layers of turns of the wire plus the two wire holes. Make the arbitrary distance, d_{ARB}, to be something that rounds the radius of the spool flanges to a favorable value.

Radius of spool flanges=r_{FLANGE}=r_{CAVITY1}+t_{EDGE1}+[N_{L}*D_{16AWG}]+d_{ARB}
d_{ARB}=3.048×10⁻⁴ m=0.012 in
r_{FLANGE}=0.17145 m=6.750 in

Next, calculate the diameter of the wire slots. The diameter of the wire slots should be at least the same diameter as that of the wire used for the device.

D_{SLOTS}>D_{16AWG} therefore D_{SLOTS}=0.0015875 m=0.0625 in

Next, calculate the positions of the centers of the wire slots on the spool flanges. The lower wire slot's center should be positioned at the same level as the first layer of wire turns and the upper wire slot's center should be positioned at the same level as the topmost layer of wire turns.

Center position of lower wire slot=r_{LSLOT}=r_{CAVITY1}+t_{EDGE1}+[½*D_{16AWG}]
r_{LSLOT}=0.1736825 m=6.838 in

Center position of upper wire slot=r_{USLOT}=r_{CAVITY1}+t_{EDGE1}+[(N_{L}−½)*D_{16AWG}]
r_{USLOT}=0.1917425 m=7.549 in

Next, decide on a width for the spool flanges. The width should be large enough to handle the mechanical stress but small enough to not add unnecessary weight to the device.
Width of the spool flanges=W_{FLANGE}=0.003175 m=0.125 in

Now, calculate the maximum voltage (V_{MAX}) required for maximum acceleration. For this calculation, caution must be made. Since the device resembles a segmented inductor, back electromotive force (EMF) plays a major role in determining the voltage needed to achieve maximum acceleration. The formula, V=[I(t)]*[Resistance]*[1/(1−e^{-t/τ})], will be used where I(t) will equal I_{MAX} and t will equal τ (in other words, t/τ=1).

V_{MAX}=I_{MAX}*R_{DEVICE}/[(1−e⁻¹)]=(17.248 A)*(64.47 Ω)/(0.632)=1759 Volts

Next, calculate the maximum acceleration and average acceleration of the device.
Maximum acceleration=a_{MAX}=F_{DEVICE}/Mass=(616N)/(268.5 kg)=2.29 m/s²
Average acceleration=a_{AVG}=½*a_{MAX}=½*(2.29 m/s²)=1.145 m/s²

Next, find the maximum velocity at the maximum force. After maximum force is reached, acceleration decreases as velocity increases. This point is known as optimal velocity.
Maximum velocity at maximum force=v_{OPT}=P_{DEVICE}/F_{DEVICE}

v_{OPT}=P_{DEVICE}/F_{DEVICE}=(48×10³ N-m/s)/616 N=77.92 m/s=174.38 mi/hr

Next, calculate the maximum velocity achievable by the device for the given mass.

v_{MAX}½*a_{AVG}*T_{MIN}=½*(1.145 m/s²)*1800s=1031 m/s=3712 km/h=2306 mi/hr

Finally, calculate the range of the device until the energy source is depleted. Range is found using the distance formula substituting a zero for initial distance and a zero for initial velocity and substituting maximum acceleration for the initial acceleration and the minimum time for the time. Average acceleration is used because as the velocity of the device increases at maximum power, the acceleration—at maximum power—decreases.
Range=R=½*(a_{AVG})*(T_{MIN})²=½*1.145 m/s²*(1800 s)²=1854900 m=1855 km=1151 mi

The specifications of the example electromagnetic force gradient propulsion device are:
16 AWG copper magnet wire with a diameter of 1.29×10⁻³ meters or 0.051 in;
1018 Low Carbon Alloy Steel is to be used for the spool;
15 layers of turns of wire is to be used;
4957 meters or 16263 feet of wire is to be used;
The diameter of the larger spindle hole cavity is 0.3004 m or 11.827 in;
The diameter of the smaller spindle hole cavity is 0.2536 m or 9.984 in;
The thickness of the narrow spindle hole edge is 0.0015875 m or 0.0625 in;
The thickness of the broad spindle hole edge is 0.0250 m or 0.984 in;
The diameter of the spool body is 0.30358 m or 11.952 in, which is twice the sum of the quantity of the radius of the spindle hole cavity and the thickness of the spindle hole cavity edge;
The total length of the spool body is 0.8404 m or 33.08 in;
The length of each spindle hole cavity is 0.4202 m or 16.54 in;
The radius of the spool flanges is 0.17145 m or 6.750 in;
The diameter of the wire slots is 0.0015875 m or 0.0625 in;
The center position of the lower wire slot is at a radius of 0.1736825 m or 6.838 in from the spool flange's center;
The center position of the upper wire slot is at a radius of 0.1917425 m or 7.549 in from the spool flange's center;
The width of the spool flanges is 0.003175 m or 0.125 in;
The total electrical resistance of the device is 64.47 Ω;
The maximum electrical current for maximum acceleration is 17.248 Amps;
The maximum voltage for maximum acceleration is 1759 Volts;
The maximum power used at maximum acceleration is 48×10³ Watts;
The maximum force exerted by the device at maximum power is 616 Newtons or 138.7 lbs;
The maximum velocity achievable by the device is 3712 km/h or 2306 mi/hr;
The range of the device using a 24 kiloWatt-hour source for a 268.5-kg (593-lb) object is 3710 kilometers or 2301 miles;
The maximum ambient temperature within to use the device is 100° C. or 212° F.

A second example device will be designed with a different set of initial conditions to show how the design process can differ.

First, discover the initial conditions for the device.
Find: The specifications of a device using the given object at a maximum acceleration. Assume neither frictional forces nor air resistance.
Given: A 371-kg (820-lb) object to have a maximum acceleration of 3.37 m/s² (11 ft/sec²) for a minimum time of 15 minutes.
Mass=m=371-kg
Acceleration=a_{MAX}=3.37 m/s²
T_{MIN}=15 min=0.25 hrs=900 s

Next, find the maximum force exerted by the device.
F_{MAX}=Mass*Acceleration=m*a_{MAX}=(371 kg)*(3.37 m/s²)=1250 N

Next, choose the wire size (wire gauge) and wire type desired for the device.
Chosen wire gauge: 18 AWG Magnet Wire-200° C. (392° F.) Rating Insulation
   D_{18AWG}=1.02×10⁻³ m=0.040 inches (in)
   I_{18AWG}=24 Amps (A)

Next, the number of layers of turns of wire is calculated. This is done by a somewhat iterative method. First, a range of the number of layers of turns of wire is chosen. Then the maximum ambient temperature of the device is chosen. Then the current is derated for each of the two factors.
Chosen range of number of layers of turns=N_{L}=15 t=>Correction factor=CF_{BUNDLED}=0.7
Chosen maximum ambient temperature=100° C. (212° F.)=>Correction factor=CF_{TEMP}=0.77

I_{MAX}=[CF_{BUNDLED}]*[CF_{TEMP}]*[I_{18AWG}]=(0.7)*(0.77)*(24 A)=12.936 A

Next, calculate the maximum value of magneto-motive force available.

MMF_{MAX}=[N_{L}*I_{MAX}]/[D_{18AWG}]

MMF_{MAX}=[15 t]*[12.936 A]/[1.02×10⁻³ m]=190235 A/m

Next, choose the magnetically permeable material for the spool body.
Chosen magnetically permeable material for spool body=1018 Steel

Now, choose the thickness of the narrow spindle hole edge. This must be large enough to be machined but small enough to cause a large magnetic field in the larger spindle hole cavity.
t_{EDGE1}=0.0015875 m=0.0625 in

Next, choose a value for the maximum magnetic field intensity (H_{CAVITY1}) and the magnetic field permeability (ur_{EDGE1}) to be desired in the larger spindle hole cavity and the narrow spindle hole edge.
H_{CAVITY1}=185000 A/m
ur_{EDGE1}=9.7 (by the data sheets for 1018 Steel for a magnetic field intensity of 185000 A/m.)
   Next, calculate the length of the larger spindle hole cavity and the smaller spindle hole cavity (L_{CAVITY}) and the length of the spool (L_{SPOOL}).
L_{CAVITY}=[t_{EDGE}*ur_{EDGE}]/[MMF_{MAX}/H_{CAVITY})−1]
L_{CAVITY}=(0.0015875 m*9.7)/[(190235 A/m)/(185000 A/m)−1]=0.5442 m=21.425 in
L_{SPOOL}=2*L_{CAVITY}=2*(0.5442 m)=1.0884 m=42.850 in

Now calculate the maximum field intensity (H_{CAVITY2}) and its relative magnetic permeability to be desired in the smaller spindle hole cavity.
H_{CAVITY2}=(0.5)*H_{CAVITY1}=92500 A/m
ur_{EDGE2}=18.3 (by the data sheets for 1018 Steel for a magnetic field intensity of 92500 A/m.)

Now, calculate the thickness of the broad spindle hole edge and the diameter of the smaller spindle hole cavity.

t_{EDGE2}=[(MMF_{MAX}/H_{CAVITY2})−1]*[L_{CAVITY}/ur_{EDGE2}]=0.0314 m=1.236 in

Now calculate the difference in the stored energy (W_{M}) by using the fact that the maximum force of the device multiplied by the cavity length gives this value.

ΔW_{M}=ΔF*L_{CAVITY}=F_{DEVICE}*L_{CAVITY}=(1250N)*(0.5442 m)=680.3 N-m=680.3 J

Now, calculate the actual number of turns that will be wound on half of the device.

N_{CAVITY}=L_{CAVITY}/D_{18AWG}*N_{L}=(0.5442 m)/(1.02×10⁻³ m)*15 t=8002 t

Next, calculate the effective area (A_{EFF}) of the device from the equation used to calculate the difference in stored energy.

ΔW_{M}=½*N_{CAVITY}*I_{MAX}*uo*(H_{CAVITY1}−H_{CAVITY2})*A_{EFF}

A_{EFF}=(2*ΔW_{M})/[N_{CAVITY}*I_{MAX}*uo*(H_{CAVITY1}−H_{CAVITY2})]

A_{EFF}=(2*680.3 N-m)/[(8002t)*(12.936A)*(4*Pi×10⁻⁷ H/m)*(185000 A/m−92500 A/m)]

A_{EFF}=0.1131 m²

Now, calculate the diameter of the smaller spindle hole cavity.

D_{CAVITY2}=√(4*A_{EFF}/Pi)=√(4*0.1131 m/Pi)=0.3795 m=14.941 in

Next, calculate the diameter of the spool.

D_{SPOOL}=D_{CAVITY2}+2*t_{EDGE2}=0.4422902 m=17.413 in

Now, calculate the diameter of the larger spindle hole cavity.
D_{CAVITY1}=D_{SPOOL}−2*t_{EDGE1}=0.4391152 m=17.288 in

Next, calculate the radius of the larger spindle hole cavity.
r_{CAVITY1}=½*D_{CAVITY1}=0.2195576 m=8.644 in

Next, calculate the radius of the spool flanges. The spool flange radius must be able to hold all the layers of turns of the wire plus the two wire holes.

Radius of spool flanges=r_{FLANGE}=r_{CAVITY1}+t_{EDGE1}+[N_{L}*D_{18AWG}]+d_{ARB}
d_{ARB}=0.0026924 m=0.106 in
r_{FLANGE}=0.22225 m=8.75 in

Next, calculate the diameter of the wire slots. The diameter of the wire slots should be at least the same diameter as that of the wire used for the device.
D_{SLOTS}>D_{18AWG} therefore D_{SLOTS}=0.0015875 m=0.0625 in

Next, calculate the positions of the centers of the wire slots on the spool flanges. The lower wire slot's center should be positioned at the same level as the first layer of wire turns and the upper wire slot's center should be positioned at the same level as the topmost layer of wire turns.

Center position of lower wire slot=r_{LSLOT}=r_{CAVITY1}+t_{EDGE1}+[½*D_{18AWG}]
r_{LSLOT}=0.2216551 m=8.727 in

Center position of upper wire slot=r_{USLOT}=r_{CAVITY1}+t_{EDGE1}+[(N_{L}−½)*D_{18AWG}]
r_{USLOT}=0.2359351 m=9.289 in

Next, decide on a width for the spool flanges. The width should be large enough to handle the mechanical stress but small enough to not add unnecessary weight to the device.
Width of the spool flanges=W_{FLANGE}=0.003175 m=0.125 in

Next, calculate the length of wire of the device.

L_{WIRE}=[2*Pi*(r_{CAVITY1}+t_{EDGE1}+½*N_{L}*D_{18AWG})]*[N_{L}/D_{18AWG}]*[L_{SPOOL}]

L_{WIRE}=[2*Pi*(0.2195576m+0.0015875m+½*15t*1.02×10⁻³m)]*[15t/1.02×10⁻³m]*[1.0884m]
L_{WIRE}=23009 m=75489 ft

Now calculate the electrical resistance of the device.

R_{DEVICE}=L_{WIRE}*ρ_{copper}/A_{18AWG}=[(23009m)*(1.7×10⁻⁸Ω−m)]/[8.171×10⁻⁷m]=479 Ω

Next, calculate the maximum voltage needed for the device for maximum acceleration.

V_{MAX}=I_{MAX}*R_{DEVICE}*[(1/(1−e⁻¹)]=(12.936 A)*(479 Ω)*(1.582)=9803 Volts

Next, calculate the maximum power needed by the device for maximum acceleration.

P_{DEVICE}=(I_{MAX})²*R_{DEVICE}/(1−e⁻¹)²=(12.936 A)²*(479 Ω)/(0.632)²=200679 W

Next, calculate the average acceleration achievable by the device for the given mass.

a_{AVG}=½*a_{MAX}=½*(3.37 m/s²)=1.685 m/s²

Next, find the maximum velocity at the maximum force. After maximum force is reached, acceleration decreases as velocity increases. This point is known as optimal velocity.
Maximum velocity at maximum force=v_{OPT}=P_{DEVICE}/F_{DEVICE}

v_{OPT}=P_{DEVICE}/F_{DEVICE}=(200679 N-m/s)/1250 N=160.54 m/s=359.12 mi/hr

Next, calculate the maximum velocity achievable by the device for the given mass.

v_{MAX}=½*a_{AVG}*T_{MIN}=½*(1.685 m/s²)*900s=758.25 m/s=2729.7 km/h=1697.6 mi/hr

Next, calculate the minimum electrical energy source needed for the device for maximum acceleration for the specified time.

E_{ELECTRICAL}=P_{DEVICE}*T_{MIN}=(200679 W)*(0.25 hrs)=50.2 kW-hrs

Finally, calculate the range of the device installed in the object until the energy source is depleted.

Range=½*(a_{AVG})*(T_{MIN})²=½*1.685 m/s²*(900s)²=682425 m=682.4 km=424 mi

The specifications of the second example electromagnetic force gradient propulsion device are:
18 AWG copper magnet wire with a diameter of 1.02×10⁻³ meters or 0.040 in;
1018 Low Carbon Alloy Steel is to be used for the spool;
15 layers of turns of wire is to be used;
23009 meters or 75489 feet of wire is to be used;
The diameter of the larger spindle hole cavity is 0.4391152 m or 17.288 in;
The diameter of the smaller spindle hole cavity is 0.3795 m or 14.941 in;
The thickness of the narrow spindle hole edge is 0.0015875 m or 0.0625 in;
The thickness of the broad spindle hole edge is 0.0314 m or 1.236 in;
The diameter of the spool body is 0.4422902 m or 17.413 in, which is twice the sum of the quantity of the radius of the spindle hole cavity and the thickness of the spindle hole cavity edge;
The total length of the spool body is 1.0884 m or 42.850 in;
The length of each spindle hole cavity is 0.5442 m or 21.425 in;
The radius of the spool flanges is 0.22225 m or 8.750 in;
The diameter of the wire slots is 0.0015875 m or 0.0625 in;
The center position of the lower wire slot is at a radius of 0.2216551 m or 8.727 in from the spool flange's center;
The center position of the upper wire slot is at a radius of 0.2359351 m or 9.289 in from the spool flange's center;
The width of the spool flanges is 0.003175 m or 0.125 in;
The total electrical resistance of the device is 479 Ω;
The maximum electrical current for maximum acceleration is 12.936 Amps;
The maximum voltage for maximum acceleration is 9803 Volts;
The maximum power used at maximum acceleration is 200679 Watts;
The maximum force exerted by the device at maximum power is 1250 Newtons or 281.5 lbs;
The maximum velocity achievable for this device is 2729.7 km/h or 1697.6 mi/hr;
The range of the device using a 50.2 kiloWatt-hour source for a 371-kg (820-lb) object is 682.4 kilometers or 424 miles;
The maximum ambient temperature within to use the device is 100° C. or 212° F.

The third design example will be shown for an object of a particular mass for a given range when the horsepower of the device is the only known required quantity.

First, discover the initial conditions for the device.
Find: The specifications of a device having the given horsepower to move a 27000-kg (59655-lb) for a range of 400 miles (643.7 km). Assume neither frictional forces nor air resistance.
Given: 161 hp to move a 27000-kg object for a range of 400 miles.
Maximum power=P_{DEVICE}=161 hp=120 kW=120×10³ W=120×10³ N-m/s
Mass=m=27000-kg
Range=400 miles=643738 m=643.7 km

Next, choose the wire size (wire gauge) and wire type desired for the device.
Chosen wire gauge: 18AWG Magnet Wire-200° C. (392° F.) Rating Insulation
   D_{18AWG}=1.02×10⁻³ m=0.040 inches (in)
   I_{18AWG}=24 Amps (A)

Next, the number of layers of turns of wire is calculated.
Chosen range of number of layers of turns=6-15=>Correction factor=CF_{BUNDLED}=0.7
Chosen maximum ambient temperature=100° C. (212° F.)=>Correction factor=CF_{TEMP}=0.77
I_{MAX}=[CF_{BUNDLED}]*[CF_{TEMP}]*[I_{18AWG}]=(0.7)*(0.77)*(24 A)=12.936 A
N_{L}=15 t

Next, calculate the maximum value of magneto-motive force available.

MMF_{MAX}=[N_{L}*I_{MAX}]/[D_{18AWG}]

MMF_{MAX}=[15 t]*[12.936 A]/[1.02×10⁻³ m]=190235 A/m

Next, choose the magnetically permeable material for the spool body.
Chosen magnetically permeable material for spool body=1018 Steel

Now, choose the thickness of the narrow spindle hole edge. This must be large enough to be machined but small enough to cause a large magnetic field in the larger spindle hole cavity.
t_{EDGE1}=0.0015875 m=0.0625 in

Next, choose a value for the maximum magnetic field intensity (H_{CAVITY1}) and the magnetic field permeability (ur_{EDGE1}) to be desired in the larger spindle hole cavity and the narrow spindle hole edge.
H_{CAVITY1}=185000 A/m
ur_{EDGE1}=9.7 (by the data sheets for 1018 Steel for a magnetic field intensity of 185000 A/m.)
   Next, calculate the length of the larger spindle hole cavity and the smaller spindle hole cavity (L_{CAVITY}) and the length of the spool (L_{SPOOL}).

L_{CAVITY}=[t_{EDGE}*ur_{EDGE}]/[(MMF_{MAX}/H_{CAVITY})−1]

L_{CAVITY}=(0.0015875m*9.7)/[(190235 A/m)/(185000 A/m)−1]=0.5442 m=21.425 in

L_{SPOOL}=2*L_{CAVITY}=2*(0.5442m)=1.0884m=42.850 in

Now calculate the maximum field intensity (H_{CAVITY2}) and its relative magnetic permeability to be desired in the smaller spindle hole cavity.
H_{CAVITY2}=(0.5)*H_{CAVITY1}=92500 A/m
ur_{EDGE2}=18.3 (by the data sheets for 1018 Steel for a magnetic field intensity of 92500 A/m.)

Now, calculate the thickness of the broad spindle hole edge and the diameter of the smaller spindle hole cavity.

t_{EDGE2}=[(MMF_{MAX}/H_{CAVITY2})−1]*[L_{CAVITY}/ur_{EDGE2}]=0.0314 m=1.236 in

Next, calculate the electrical resistance of the device from the electrical power equation.

R_{DEVICE}=P_{DEVICE}*(1−e⁻¹)²/(I_{MAX})=(120×10³ W)*(0.632)²/(12.936 A)²=286 Ω

Now calculate the length of wire of the device.

L_{WIRE}=R_{DEVICE}*A_{18AWG}/τ_{copper}=[(286 Ω)*(8.171×10⁻⁷m²)/[1.7×10⁻⁸Ω−m]=13747 m=45102 ft

Next, calculate the radius and diameter of the larger spindle hole cavity.

L_{WIRE}=[2*Pi*(r_{CAVITY1}+t_{EDGE1}+½*N_{L}*D_{18AWG})]*[N_{L}/D_{18AWG}]*[L_{SPOOL}]

r_{CAVITY1}=[L_{WIRE}*D_{18AWG}]/[2*Pi*N_{L}*L_{SPOOL}]−t_{EDGE1}−½*N_{L}*D_{18AWG}
r_{CAVITY1}=0.127456 m=5.018 in
D_{CAVITY1}=2*r_{CAVITY1}=2*0.127456 m=0.254912 m=10.036 in

Next, calculate the diameter of the spool.

D_{SPOOL}=D_{CAVITY1}+2*t_{EDGE1}=0.258087 m=10.161 in

Now, calculate the diameter of the smaller spindle hole cavity.

D_{CAVITY2}=D_{SPOOL}−2*t_{EDGE2}=0.19530 m=7.689 in

Next, calculate the effective area (A_{EFF}) of the device from the diameter of the smaller spindle hole cavity.

A_{EFF}=Pi*(D_{CAVITY2})²/4=Pi*(0.19530 m)²/4=0.02996 m²

Now, calculate the actual number of turns that will be wound on half of the device.

N_{CAVITY}=L_{CAVITY}/D_{18AWG}*N_{L}=(0.5442 m)/(1.02×10⁻³ m)*15 t=8002 t

Now calculate the difference in the stored energy (W_{M}).

ΔW_{M}=½*N_{CAVITY}*I_{MAX}*uo*(H_{CAVITY1}−H_{CAVITY2})*A_{EFF}

ΔW_{M}=½*(8002t)*(12.936 A)*(4*Pi×10⁻⁷ H/m)*(185000 A/m−92500 A/m)*(0.02996m²)

ΔW_{M}=180 J=180 N-m

Now calculate the maximum force exerted by the device (ΔF) by using the fact that the difference in stored energy divided by the cavity length gives this value.

ΔF=F_{DEVICE}=ΔW_{M}/L_{CAVITY}=(180 N-m)/(0.5442m)=331 N=74.55 lbs

Next, calculate the radius of the spool flanges. The spool flange radius must be able to hold all the layers of turns of the wire plus the two wire holes.

Radius of spool flanges=r_{FLANGE}=r_{CAVITY1}+t_{EDGE1}+[N_{L}*D_{18AWG}]+d_{ARB}
d_{ARB}=0.0017018 m=0.067 in
r_{FLANGE}=0.14605 m=5.750 in

Next, calculate the diameter of the wire slots. The diameter of the wire slots should be at least the same diameter as that of the wire used for the device.
D_{SLOTS}>D_{18AWG} therefore D_{SLOTS}=0.0015875 m=0.0625 in

Next, calculate the positions of the centers of the wire slots on the spool flanges. The lower wire slot's center should be positioned at the same level as the first layer of wire turns and the upper wire slot's center should be positioned at the same level as the topmost layer of wire turns.

Center position of lower wire slot=r_{LSLOT}=r_{CAVITY1}+t_{EDGE1}+[½*D_{18AWG}]
r_{LSLOT}=0.1295535 m=5.101 in

Center position of upper wire slot=r_{USLOT}=r_{CAVITY1}+t_{EDGE1}+[(N_{L}−½)*D_{18AWG}]
r_{USLOT}=0.1438335 m=5.663 in

Next, decide on a width for the spool flanges. The width should be large enough to handle the mechanical stress but small enough to not add unnecessary weight to the device.
Width of the spool flanges=W_{FLANGE}=0.003175 m=0.125 in

Next, calculate the maximum voltage needed for the device for maximum acceleration.

V_{MAX}=I_{MAX}*R_{DEVICE}*[(1/(1−e⁻¹)]=(12.936 A)*(453 Ω)*(1.582)=9270.5 Volts

Next, find the maximum velocity at the maximum force. After maximum force is reached, acceleration decreases as velocity increases. This point is known as optimal velocity.
Maximum velocity at maximum force=v_{OPT}=P_{DEVICE}/F_{DEVICE}

v_{OPT}=P_{DEVICE}/F_{DEVICE}=(120×10³ N-m/s)/331 N=362.54 m/s=811.3 mi/hr

Next, find the maximum acceleration and average acceleration exerted by the device.
a_{MAX}=F_{MAX}/Mass=(311 N)/(27000 kg)=0.0115 m/s² (0 to 89 km/h in 39.13 minutes.)
a_{AVG}=½*a_{MAX}=½*0.0115 m/s²=0.00575 m/s²

Next, calculate the minimum operating time of the device.

T_{MIN}=√(2*Range/a_{AVG})=√(2*643738 m/0.00575 m/s²)=14964 sec=249.4 min=4.157 hrs

Next, calculate the maximum velocity achievable by the device for the given mass.

v_{MAX}=½*a_{AVG}*T_{MIN}=½*(0.0115 m/s²)*14964s=86.043 m/s=309.8 km/h=192.5 mi/hr

Finally, calculate the minimum electrical energy source needed for the device for maximum acceleration for the specified time.

E_{ELECTRICAL}=P_{DEVICE}*T_{MIN}=(120×10³ W)*(4.157 hrs)=498.8 kW-hrs

The specifications of the third example electromagnetic force gradient propulsion device are:
18 AWG copper magnet wire with a diameter of 1.02×10⁻³ meters or 0.040 in;
1018 Low Carbon Alloy Steel is to be used for the spool;
15 layers of turns of wire is to be used;
13747 meters or 45102 feet of wire is to be used;
The diameter of the larger spindle hole cavity is 0.254912 m or 10.036 in;
The diameter of the smaller spindle hole cavity is 0.19530 m or 7.689 in;
The thickness of the narrow spindle hole edge is 0.0015875 m or 0.0625 in;
The thickness of the broad spindle hole edge is 0.0314 m or 1.236 in;
The diameter of the spool body is 0.258087 m or 10.161 in, which is twice the sum of the quantity of the radius of the spindle hole cavity and the thickness of the spindle hole cavity edge;
The total length of the spool body is 1.0884 m or 42.850 in;
The length of each spindle hole cavity is 0.5442 m or 21.425 in;
The radius of the spool flanges is 0.14605 m or 5.750 in;
The diameter of the wire slots is 0.0015875 m or 0.0625 in;
The center position of the lower wire slot is at a radius of 0.1295535 m or 5.101 in from the spool flange's center;
The center position of the upper wire slot is at a radius of 0.1438335 m or 5.663 in from the spool flange's center;
The width of the spool flanges is 0.003175 m or 0.125 in;
The total electrical resistance of the device is 286 Ω;
The total electrical current for maximum acceleration is 12.936 Amps;
The maximum voltage for maximum acceleration is 9270.5 Volts;
The maximum power used at maximum acceleration is 120×10³ Watts;
The maximum force exerted by the device at maximum power is 331 Newtons or 74.55 lbs;
The maximum velocity achievable for this device is 309.8 km/h or 192.5 mi/hr;
The range of the device using a 498.8 kiloWatt-hour source for a 27000-kg (59655-lb) object is 643.7 kilometers or 400 miles;
The maximum ambient temperature within to use the device is 100° C. or 212° F.

The fourth design example will show a more common way of designing an electromagnetic force differential propulsion device and that is when the desired torque is the known quantity.

First, discover the initial conditions for the device.
Find: The specifications of a pair of devices having the combined torque to move a 6×6, 27000-kg (59655-lb) vehicle for 250 miles (402.3 km) which originally used a 4474 N-m (3300 lb-ft) motor. Assume neither frictional forces nor air resistance.
Given: 4474 N-m original motor used to move a 27000-kg vehicle for a range of 250 miles. The vehicle's wheeltrack is 2530 mm and the vehicle's wheelbase is 6200 mm.
Mass=m=27000-kg
Range=250 miles=402336 m=402.3 km
Wheeltrack=2530 mm=2.530 m
Wheelbase=6200 mm=6.200 m

Next, calculate the necessary torque for each device. Remember that the original torque is multiplied by 6 due to the fact that the original motor's torque is moving each of the 6×6's wheels (6 wheels in total). Also the torque of the devices is equivalent to the change in stored energy of the devices. The explanation for multiplying by half will be given in the next step.
ΔW_{M}=½*(Number of wheels moved by motor)*Torque=½*6*4474 N-m=13422 N-m=9900 lb-ft

Next, calculate the length of the spool body of the devices. This value is determined by the length of the effective length of the vehicle or the wheelbase. Usually four devices will be paired parallel in a vehicle with two devices inline on the left side (one for forward and one for reverse) and the remaining two devices inline on the right side (one for forward and one for reverse). Only the forward-moving parallel pair will be calculated. Since only two are always on, vehicle torque and power are halved.

L_{SPOOL}=½*(Wheelbase)=½*(6.2 m)=3.1 m=122 in

Next, calculate the length of the cavities of the devices. Each parallel cavity is equivalent.

L_{CAVITY}=½*L_{SPOOL}=½*(3.1 m)=1.55 m=61 in

Next, calculate the desired force of each device.

ΔF=ΔW_{M}/L_{CAVITY}=13422 N-m/1.55 m=8659 N=1950 lbs

Next, decide the smaller spindle hole cavity diameter (D_{CAVITY2}) and the effective area (A_{EFF}) of each device. The maximum possible value for the effective area will be determined by the wheeltrack.

MAX D_{SPOOL}=[½*Wheeltrack−(Wheel width)]=[(½*2.530m)−0.19901m]=1.06599 m=41.968 in

D_{CAVITY2}=75%*MAX D_{SPOOL}=(0.75)*1.06599 m=0.79949 m=31.476 in

A_{EFF}=PI*(D_{CAVITY2})²/4=0.5020 m²

Next, choose the magnetically permeable material for the body of the spool. 1018 Low Carbon Alloy Steel is chosen.

Next, calculate the magnetic field intensity of the smaller spindle hole cavity and its relative magnetic permeability and the maximum magnetomotive force from the change in energy equation. This will be a conditional solve. A value for the maximum magnetomotive force will be decided and the magnetic field intensity of the smaller spindle hole cavity will be calculated but the intensity must be less than half of the maximum magnetomotive force's value.

ΔF=ΔW_{M}/L_{CAVITY}=½*uo*[N_{CAVITY}*I_{MAX}/L_{CAVITY}]*(H_{CAVITY1}−H_{CAVITY2})*A_{EFF}

MMF_{MAX}=N_{CAVITY}*I_{MAX}/L_{CAVITY} (Defining equation for magnetomotive force.)

H_{CAVITY1}=2*H_{CAVITY2} (Conditional equation of the propulsion device at maximum power.)

ΔF=½*uo*MMF_{MAX}*H_{CAVITY2}*A_{EFF} (Derived equation.)

MMF_{MAX}*H_{CAVITY2}=2*ΔF/(uo*A_{EFF})=2.7453×10¹⁰ A²/m²
Chosen values: MMF_{MAX}=247059 A/m
   H_{CAVITY2}=111119 A/m ur_{EDGE2}=15.7

Next, choose the value of the narrow spindle hole edge.

t_{EDGE2}=[MMF_{MAX}/H_{CAVITY2}−1]*[L_{CAVITY}/ur_{EDGE2}]=0.12078 m32 4.755 in

Next, calculate the diameter of the spool body.

D_{SPOOL}=D_{CAVITY2}+2*t_{EDGE2}=1.04104 m=40.986 in

Next, calculate the magnetic field intensity of the larger spindle hole cavity and its relative magnetic permeability.
H_{CAVITY1}=2*H_{CAVITY2}=2*(111119 A/m)=222238 A/m
ur_{EDGE1}=8.55

Next, calculate the value of the broad spindle hole edge.

t_{EDGE1}=[MMF_{MAX}/H_{CAVITY1}−1]*[L_{CAVITY}/ur_{EDGE1}]=0.02025 m=0.797 in

Next, calculate the diameter and the radius of the larger spindle hole cavity.

D_{CAVITY1}−2*t_{EDGE1}=1.000 m=39.392 in

r_{CAVITY1}=½*D_{CAVITY1}=0.500 m=19.696 in

Next, choose the wire size (wire gauge) and wire type desired for the devices.
Chosen wire gauge: 18AWG Magnet Wire-200° C. (392° F.) Rating Insulation
   D_{18AWG}=1.02×10⁻³ m=0.040 inches (in)
   I_{18AWG}=24 Amps (A)
   A_{18AWG}=8.171×10⁻⁷ m²
   p_{COPPER}=1.7×10⁻⁸ Ω−m

Next, the number of layers of turns of wire is calculated.
Chosen range of number of layers of turns=N_{L}=15 t=>Correction factor=CF_{BUNDLED}=0.7

Next, calculate the maximum current allowed from the basic maximum magnetomotive force equation.

MMF_{MAX}=N_{L}*I_{MAX}/D_{18AWG}=>I_{MAX}=MMF_{MAX}*D_{18AWG}/N_{L}=16.8 A

Next, calculate the maximum ambient temperature.

I_{MAX}=CF_{BUNDLED}*CF_{TEMP}*I_{18AWG}=16.8 A

CF_{TEMP}=I_{MAX}/[CF_{BUNDLED}*I_{18AWG}]=1.0=>55° C. (131° F.)

Now calculate the length of wire of wound around each device.

L_{WIRE}=[2*Pi*(r_{CAVITY1}+t_{EDGE1}+½*N_{L}*D_{18AWG})]*[N_{L}/D_{18AWG}]*[L_{SPOOL}]
L_{WIRE}=152211 m=499380 ft

Next, calculate the electrical resistance of each device.

R_{DEVICE}=L_{WIRE}*p_{COPPER}/A_{18AWG}=(152211 m)*(1.7×10⁻⁸Ω−m)/8.171×10⁻⁷ m²=3167 Ω

Next, calculate the maximum power required by each device.

P_{DEVICE}=(I_{MAX})²*R_{DEVICE}/(1−e⁻¹)²=(16.8 A)²*(3167 Ω)/(0.632)²=2237858 W=3000 hp

Next, calculate the radius of the spool flanges. The spool flange radius must be able to hold all the layers of turns of the wire plus the two wire holes.

Radius of spool flanges=r_{FLANGE}=r_{CAVITY1}+t_{EDGE1}+[N_{L}*D_{18AWG}]+d_{ARB}
d_{ARB}=0.001016 m=0.040 in
r_{FLANGE=}0.536575 m=21.125 in

Next, calculate the diameter of the wire slots. The diameter of the wire slots should be at least the same diameter as that of the wire used for the device.
D_{SLOTS}>D_{18AWG} therefore D_{SLOTS}=0.0015875 m=0.0625 in

Next, calculate the positions of the centers of the wire slots on the spool flanges. The lower wire slot's center should be positioned at the same level as the first layer of wire turns and the upper wire slot's center should be positioned at the same level as the topmost layer of wire turns.

Center position of lower wire slot=r_{LSLOT}=r_{CAVITY1}+t_{EDGE1}+[½*D_{18AWG}]
r_{LSLOT}=0.52076 m=20.502 in

Center position of upper wire slot=r_{USLOT}=r_{CAVITY1}+t_{EDGE1}+[(N_{L}−½)*D_{18AWG}]
r_{USLOT}=0.53504 m=21.065 in

Next, decide on a width for the spool flanges. The width should be large enough to handle the mechanical stress but small enough to not add unnecessary weight to the device.
Width of the spool flanges=W_{FLANGE}=0.003175 m=0.125 in

Next, calculate the maximum voltage needed for the device for maximum acceleration.

V_{MAX}=I_{MAX}*R_{DEVICE}/[(1−e⁻¹)]=(16.8 A)*(3167 Ω)*(0.632)=84186 Volts

Next, find the maximum velocity at the maximum force. After maximum force is reached, acceleration decreases as velocity increases. This point is known as optimal velocity.
Maximum velocity at maximum force=v_{OPT}=P_{DEVICE}/F_{DEVICE}

v_{OPT}=P_{DEVICE}/F_{DEVICE}=(2237858 N-m/s)/8659 N=258 m/s=929 mi/hr

Next, find the maximum acceleration exerted by each device.

a_{MAX}=F_{DEVICE}/Mass=(8659 N)/(27000 kg)=0.321 m/s² (0 to 27 m/s in 84 sec.)

Next, calculate the maximum acceleration and the average acceleration exerted by the pair of devices on the vehicle.

a_{VEHICLE-MAX}=2*a_{MAX}=0.642 m/s² (0 to 27 m/s in 42.1 sec.)

a_{AVG}=½*a_{VEHICLE-MAX}=½*0.624 m/s²=0.321 m/s²

Next, calculate the minimum operating time of the vehicle.

T_{MIN}=√(2*Range/a_{AVG})=√[(2*402336m)/(0.321 m/s²)]=1583 sec=0.4397 hrs

Next, calculate the maximum velocity achievable by the vehicle.

v_{MAX}=½*a_{AVG}*T_{MIN}=½*(0.321 m/s²)*1583s=254 m/s=914 km/h=569 mi/hr

Finally, calculate the minimum electrical energy source needed for the pair of devices to move the vehicle for the maximum acceleration for the specified time.

E_{ELECTRICAL}=2*P_{DEVICE}*T_{MIN}=2*(2237858 W)*(0.4397 hrs)=1967972 W−hrs=1.97 MW−hrs

The specifications of the fourth example electromagnetic force gradient propulsion device are:
18 AWG copper magnet wire with a diameter of 1.02×10⁻³ meters or 0.040 in;
1018 Low Carbon Alloy Steel is to be used for the spool;
15 layers of turns of wire is to be used;
152211 meters or 499380 feet of wire is to be used;
The diameter of the larger spindle hole cavity is 1.000 m or 39.392 in;
The diameter of the smaller spindle hole cavity is 0.79948 m or 31.476 in;
The thickness of the narrow spindle hole edge is 0.02025 m or 0.797 in;
The thickness of the broad spindle hole edge is 0.12078 m or 4.755 in;
The diameter of the spool body is 1.04104 m or 40.986 in, which is twice the sum of the quantity of the radius of the spindle hole cavity and the thickness of the spindle hole cavity edge;
The total length of the spool body is 3.100 m or 122 in;
The length of each spindle hole cavity is 1.55 m or 61 in;
The radius of the spool flanges is 0.536575 m or 21.125 in;
The diameter of the wire slots is 0.0015875 m or 0.0625 in;
The center position of the lower wire slot is at a radius of 0.52076 m or 20.502 in from the spool flange's center;
The center position of the upper wire slot is at a radius of 0.53504 m or 21.065 in from the spool flange's center;
The width of the spool flanges is 0.003175 m or 0.125 in;
The total electrical resistance of each device is 3167 Ω;
The maximum electrical current for maximum acceleration is 16.8 Amps;
The maximum voltage for maximum acceleration is 84186 Volts;
The maximum power used at maximum acceleration by each device is 2237858 Watts;
The maximum force exerted by each device at maximum power is 8659 Newtons or 1950 lbs;
The maximum velocity achievable for this Vehicle is 914 km/h or 569 mi/hr;
The range of this Vehicle using a 1.97 MegaWatt-hour source for a 27000-kg (59655-lb) object is 402 kilometers or 250 miles;
The maximum ambient temperature within to use the device is 55° C. or 131° F.

The fifth example will show how to calculate the force exerted by an electromagnetic force differential propulsion device using a current less than the maximum required by the device. The previous example's device will be used to illustrate this design process and set of initial conditions.

First, discover the initial conditions of the device.
Find: The force exerted by only one of the previous example's device while the device is consuming only 5 Amps of current. Assume neither frictional forces nor air resistance.
Given: I_{MAX}=5 A
Mass=m=27000 kg
A_{EFF}=0.5020 m²
18 AWG copper magnet wire with a diameter of 1.02×10⁻³ meters or 0.040 in;
1018 Low Carbon Alloy Steel is to be used for the spool;
15 layers of turns of wire is to be used;
152211 meters or 499380 feet of wire is to be used;
The diameter of the larger spindle hole cavity is 1.000 m or 39.392 in;
The diameter of the smaller spindle hole cavity is 0.79948 m or 31.476 in;
The thickness of the narrow spindle hole edge is 0.02025 m or 0.797 in;
The thickness of the broad spindle hole edge is 0.12078 m or 4.755 in;
The diameter of the spool body is 1.04104 m or 40.986 in;
The total length of the spool body is 3.100 m or 122 in;
The length of each spindle hole cavity is 1.55 m or 61 in;
The radius of the spool flanges is 0.536575 m or 21.125 in;
The diameter of the wire slots is 0.0015875 m or 0.0625 in;
The center position of the lower wire slot is at a radius of 0.52076 m or 20.502 in from the spool flange's center;
The center position of the upper wire slot is at a radius of 0.53504 m or 21.065 in from the spool flange's center;
The width of the spool flanges is 0.003175 m or 0.125 in;
The total electrical resistance of the device is 3167 Ω;
The maximum ambient temperature within to use the device is 55° C. or 131° F.

Next, calculate the maximum magnetomotive force at I_{MAX}.

MMF_{MAX}=N_{L}*I_{MAX}/D_{18AWG}=(15 t)*(5 A)/1.02×10⁻³ m=73529 A/m

Next, calculate the magnetic field intensity in the larger spindle hole cavity.

[1+t_{EDGE1}*ur_{EDGE1}/L_{CAVITY]*H}_{CAVITY1}=MMF_{MAX}
H_{CAVITY1}=51852 A/m
ur_{EDGE1}=32

Next, calculate the magnetic field intensity in the smaller spindle hole cavity. Caution! This value is half of the magnetic field intensity of the larger spindle hole cavity ONLY at maximum power. Due to this, the correct magnetic field intensity at any other magnitude of power can only be achieved using the derived boundary condition equation.

[1+t_{EDGE2}*ur_{EDGE2}/L_{CAVITY}]*H_{CAVITY2}=MMF_{MAX}
H_{CAVITY2}=1468 A/m
ur_{EDGE2}=630

Next, calculate the number of turns surrounding each cavity. This value is the same value as in the previous example's devices but the value was not specifically shown.

N_{CAVITY}=L_{CAVITY}/D_{18AWG}*N_{L}=(1.55m)*(15t)/1.02×10⁻³ m=22794 t

Next, calculate the change in stored energy.

ΔW_{M}=½*uo*N_{CAVITY}*I_{MAX}*(H_{CAVITY1}−H_{CAVITY2})*A_{EFF}

ΔW_{M}=½*(4*PI×10⁻⁷ H/m)*22794t*(5A)*(51852 A/m−1468 A/m)*0.5020 m²=1811 J=1811 N-m

Next, calculate the force exerted by the device.

ΔF=ΔW_{M}/L_{CAVITY}=1811 N-m/1.55m=1168 N=263 lbs

Next, calculate the power consumed by the device at 5 Amps.

P_{DEVICE}=(I_{MAX})²*R_{DEVICE}/(1−e⁻¹)²=(5A)²*(3167 Ω)/[0.632]²=198223 W

Next, calculate the acceleration of the device at 5 Amps.

a_{5AMPS}=ΔF/m=(1168N)/(27000 kg)=0.0433 m/s²

Recap of the calculations:
Force of the device at an electrical current of 5 Amps is 1168 N or 263 lbs;
Power of the device at an electrical current of 5 Amps is 198223 W; and
Acceleration of a 27000 kg load using one device is 0.0433 m/s².

The sixth example will show how to calculate the force exerted by another embodiment of the electromagnetic force differential propulsion device. This embodiment features the magnetically permeable spool insert in place of the larger spindle hole cavity.

First, discover the initial conditions of the device.
Find: The force exerted by only one of the fourth example's device while the device is at maximum power using a magnetically permeable spool insert instead of the larger spindle hole cavity. Assume neither frictional forces nor air resistance.
Given: P_{MAX}=P_{DEVICE}=2237858 W
   I_{MAX}=16.8 A
   R_{DEVICE}=3167 Ω
Mass=m=27000 kg
18 AWG copper magnet wire with a diameter of 1.02×10⁻³ meters or 0.040 in;
1018 Low Carbon Alloy Steel is to be used for the spool;
15 layers of turns of wire is to be used; (N_{L}=15)
152211 meters or 499380 feet of wire is to be used;
The diameter of the smaller spindle hole cavity is 0.79948 m or 31.476 in; (D_{CAVITY2})
The thickness of the broad spindle hole edge is 0.12078 m or 4.755 in; (t_{EDGE2})
The diameter of the spool body is 1.04104 m or 40.986 in;
The total length of the spool body is 3.100 m or 122 in;
The length of each spindle hole cavity is 1.55 m or 61 in; (L_{CAVITY})
The radius of the spool flanges is 0.536575 m or 21.125 in;
The diameter of the wire slots is 0.0015875 m or 0.0625 in;
The center position of the lower wire slot is at a radius of 0.52076 m or 20.502 in from the spool flange's center;
The center position of the upper wire slot is at a radius of 0.53504 m or 21.065 in from the spool flange's center;
The width of the spool flanges is 0.003175 m or 0.125 in;
The maximum ambient temperature within to use the device is 55° C. or 131° F.

Next, determine the diameter and length of the magnetically permeable spool insert.
D_{INSERT}=D_{CAVITY1}=1.000 m=39.392 in
L_{INSERT}=L_{CAVITY}=1.55 m=61 in

Next, calculate the maximum magnetomotive force at I_{MAX}.

MMF_{MAX}=N_{L}*I_{MAX}/D_{18AWG}=(15 t)*(16.8 A)/1.02×10⁻³ m=247059 A/m

Next, calculate the magnetic field intensity in the smaller spindle hole cavity and the magnetic permeability of the narrow spindle hole edge (now called the general spindle hole cavity and the general spindle hole edge, respectively).

[1+t_{EDGEG}*ur_{EDGEG}/L_{CAVITY]*H}_{CAVITYG}=MMF_{MAX}
H_{CAVITYG}=111119 A/m
ur_{EDGEG}=15.7

Next, calculate the magnetic field intensity in the spindle hole cavity occupied by the spool insert. Caution! The magnetic field intensities used in these equations are calculated for non-magnetically permeable materials only. Due to this and the fact that the magnetically permeable spool insert is used, the magnetic field intensity of the larger spindle hole cavity is and always will be zero. The relative magnetic permeability of the narrow spindle hole edge is not required to be known.
H_{CAVITYI}=0 A/m

Next, calculate the number of turns surrounding each cavity. This value is the same value as in the previous example's devices but will be specifically shown again.

N_{CAVITY}=L_{CAVITY}/D_{18AWG}*N_{L}=(1.55m)*(15t)/1.02×10⁻³ m=22794 t

Next, calculate the effective area of the device. This value is calculated, as usual, from the diameter of the general spindle hole cavity.

A_{EFF}=PI*(D_{CAVITYG})²/4=0.5020 m²

Next, calculate the change in stored energy.

ΔW_{M}=½*uo*N_{CAVITY}*I_{MAX}*(H_{CAVITY1}−H_{CAVITY2})*A_{EFF}

ΔW_{M}=½*(4*PI×10⁻⁷ H/m)*22794t*(16.8 A)*(0 A/m−111119 A/m)*0.5020 m²

ΔW_{M}=−13421.5 J=−13421.5 N-m

Next, calculate the force exerted by the device.

ΔF=ΔW_{M}/L_{CAVITY}=−13421.5 N-m/1.55 m=−8659 N=−1950 lbs

Notice the sign in both the change in stored energy and the exerted force is negative. This is to show the device is moving in the direction of the general spindle hole cavity when the general spindle hole cavity is on the left. Also, notice the device's calculated force is identical to the fourth example device's calculated force. This means there is little merit in using a magnetically permeable spool insert instead of the larger spindle hole cavity. Not only is there no significant added exerted force, the spool insert also adds unnecessary weight which can be very noticeable for larger devices.

Next, calculate the acceleration of the device. Notice in the equation, the absolute value of the calculated force is used. This is done due to the fact that a negative acceleration usually means slowing down and not necessarily a direction change.

a_{MAX}=|ΔF|/m=|(−8659N)|/(27000 kg)=0.321 m/s²

Recap of the calculations:
Force of the device at a maximum power is 8659 N or 1950 lbs in the direction of the smaller spindle hole cavity;
Acceleration of a 27000 kg load using one device is 0.321 m/s².

The final example will show how to calculate the force exerted by an embodiment featuring the magnetically permeable spool insert in place of the smaller spindle hole cavity.

First, discover the initial conditions of the device.
Find: The force exerted by only one of the fourth example's device while the device is at maximum power using a magnetically permeable spool insert instead of the smaller spindle hole cavity. Assume neither frictional forces nor air resistance.
Given: P_{MAX}=P_{DEVICE}=2237858 W
   I_{MAX}=16.8 A
   R_{DEVICE}=3167 Ω
Mass=m=27000 kg
18 AWG copper magnet wire with a diameter of 1.02×10⁻³ meters or 0.040 in;
1018 Low Carbon Alloy Steel is to be used for the spool;
15 layers of turns of wire is to be used; (N_{L}=15)
152211 meters or 499380 feet of wire is to be used;
The diameter of the larger spindle hole cavity is 1.000 m or 39.392 in;
The thickness of the narrow spindle hole edge is 0.02025 m or 0.797 in;
The diameter of the spool body is 1.04104 m or 40.986 in;
The total length of the spool body is 3.100 m or 122 in;
The length of each spindle hole cavity is 1.55 m or 61 in;
The radius of the spool flanges is 0.536575 m or 21.125 in;
The diameter of the wire slots is 0.0015875 m or 0.0625 in;
The center position of the lower wire slot is at a radius of 0.52076 m or 20.502 in from the spool flange's center;
The center position of the upper wire slot is at a radius of 0.53504 m or 21.065 in from the spool flange's center;
The width of the spool flanges is 0.003175 m or 0.125 in;
The maximum ambient temperature within to use the device is 55° C. or 131° F.

Next, determine the diameter and length of the magnetically permeable spool insert.
D_{INSERT}=D_{SPOOL}=0.79948 m=31.476 in
L_{INSERT}=L_{CAVITY}=1.55 m=61 in

Next, calculate the maximum magnetomotive force at I_{MAX}.

MMF_{MAX}=N_{L}*I_{MAX}/D_{18AWG}=(15 t)*(16.8 A)/1.02×10⁻³ m=247059 A/m

Next, calculate the magnetic field intensity in the larger spindle hole cavity and the relative magnetic permeability of the narrow spindle hole edge (now called the general spindle hole cavity and general spindle hole edge, respectively).

[1+t_{EDGEG}*ur_{EDGEG}/L_{CAVITY}]*H_{CAVITYG}=MMF_{MAX}
H_{CAVITYG}=222238 A/m
ur_{EDGEG}=8.55

Next, calculate the magnetic field intensity in the spindle hole cavity occupied by the spool insert. Caution! The magnetic field intensities used in these equations are calculated for non-magnetically permeable materials only. Due to this and the fact that the magnetically permeable spool insert is used, the magnetic field intensity of the smaller spindle hole cavity is and always will be zero. The relative magnetic permeability of the broad spindle hole edge is not required to be known.
H_{CAVITYI}=0 A/m

Next, calculate the number of turns surrounding each cavity. This value is the same value as in the previous example's devices but will be specifically shown again.

N_{CAVITY}=L_{CAVITY}/D_{18AWG}*N_{L}=(1.55m)*(15t)/1.02×10⁻³ m=22794 t

Next, calculate the effective area of the device. The diameter of the general spindle hole cavity will be used to calculate the effective area because it is the only non-magnetically permeable volume within the device.

A_{EFF}=PI*(D_{CAVITYG})²/4=0.7854 m²

Next, calculate the change in stored energy.

ΔW_{M}=½*uo*N_{CAVITY}*I_{MAX}*(H_{CAVITYG}-H_{CAVITYI})*A_{EFF}

ΔW_{M}=½*(4*PI×10⁻⁷ H/m)*22794t*(16.8A)*(222238 A/m−0 A/m)*0.7854 m²

ΔW_{M}=41997 J=41997 N-m

Next, calculate the force exerted by the device.

ΔF=ΔW_{M}/L_{CAVITY}=41997 N-m/1.55m=27095 N=6102 lbs

Notice the sign in both the change in stored energy and the exerted force is positive. This is to show the device is moving in the direction of the general spindle hole cavity when the general spindle hole cavity is on the right. Also, notice the device's calculated force is much larger to the fourth example device's calculated force. This means it may be beneficial to use a magnetically permeable spool insert instead of the smaller spindle hole cavity but caution must be made for the spool insert also adds unnecessary weight which can be very noticeable for larger devices.

Next, calculate the acceleration of the device. Notice in the equation, the absolute value of the calculated force is used. This is done due to the fact that a negative acceleration usually means slowing down and not necessarily a direction change.

a_{MAX}=ΔF/m=(27095N)/(27000 kg)=1.004 m/s²

Recap of the calculations:
Force of the device at a maximum power is 27095 N or 6102 lbs in the direction of the smaller spindle hole cavity;
Acceleration of a 27000 kg load using one device is 1.004 m/s².

To assemble the preferred embodiment of the electromagnetic force differential propulsion device, strip the ends of the correctly desired length of insulated electrical wire (1) from their insulation and push one of the wire ends (2) through a lower wire slot (5) from the inside of the spool flange (3) of the spool body (10) to the outside of the spool flange (3) of the spool body (10). Wrap the insulated electrical wire (1) around the spool body (10) of the device between the spool flanges (3) for as many layers for which the device was designed. Last, place the free remaining wire end (2) of the insulated electrical wire (1) through an upper wire slot (4) of a spool flange (3).

To operate an electromagnetic force differential propulsion device, connect the positive terminal of an electrical power source to a wire end (2) pushed through the outside of the device and connect the negative terminal of the same electrical power source to the remaining wire end (2) of the insulated electrical wire (1) of the device. Adjust the magnitude of electrical current from the electrical power source between zero and the maximum amount of electrical current for which the device was designed to change the force (12) exhibited and exerted by the device.

Different magnetically permeable materials will cause different values of force (12). The reason is due to the varying range of values of magnetic field densities induced in each material for the same range of currents. To note, the difference in the sizes of the cross-sectional areas of the larger spindle hole cavity (6) and the smaller spindle hole cavity (7) will affect the force (12) exerted by the device as well. The reason is that as the cavities (6, 7) grow larger, the magnitude of magnetic field intensity will increase due to smaller spindle hole edges (8, 9). The smaller the spindle hole edges (8, 9) are, the more the magnetic field will flow in the cavities (6, 7). Either cavity can be adjusted individually for varying exerted forces (12) by the same size spool body (10). When both cavities (6, 7) are the same size, their respective magnetic field intensities are equal and, therefore, each cavity (6, 7) pulls the device equally but in opposite directions causing a zero net force to be exerted on and by the device. The smaller spindle hole cavity's (7) absolute cross-sectional area's size is another main factor in determining the magnetic field intensity flowing through the spool body and the force (12) being generated due to the fact that the larger the area, the higher a force (12) that can be exerted. The premiere factor in determining the magnetic field intensity and exerted force (12) is the maximum amount of power being input to the device. It is important to make the length of the cavities, at their smallest value, equivalent to the larger spindle hole cavity's (6) diameter to achieve near-calculated results, if the device is manufactured. This is due to the fact that small magnetic shielding bodies attenuate magnetic fields better than larger magnetic shielding bodies. Therefore, a smaller force (12) is exerted from smaller electromagnetic force differential propulsion devices. As a final note, the actual exerted force (12) may be different than calculated due to real world conditions unaccounted for.

1. I claim an electrical device comprising:
one length of wire and
a spool wherein the constitution of said spool comprises a body of magnetically permeable material with a cavity filled with a non-magnetically permeable material where said cavity is an n-prism of unique arbitrary perimeter where said cavity possesses an arbitrary longitudinal axial length that is less than the total longitudinal axial length of the spool,
where the said length of wire is wound around the said spool causing the said electrical device to exert a force parallel to the said spool's longitudinal axis whenever the said length of wire is conducting.

2. I claim the electrical device of claim 1 wherein the said spool contains no flanges.
